(19) United States
(12) Patent Application Publication
(10) Pub. No.: US 2012/0084250 A1
(43) Pub. Date: Apr. 5, 2012

(54) DATA WRITE-BACK TO DATA PROVIDER FROM INDIVIDUAL GRID CELLS

(75) Inventors: Sergei Gundorov, Kirkland, WA (US); Pablo Trejo Montemayor, Seattle, WA (US); Sreepada Santhegudda, Bellevue, WA (US)

(73) Assignee: MICROSOFT CORPORATION, Redmond, WA (US)

(21) Appl. No.: 12/894,241

(22) Filed: Sep. 30, 2010

(51) Int. Cl. G06F 17/00

(52) U.S. Cl. 707/600; 707/E17.005

(57) ABSTRACT

Architecture that provides an asymmetrical data approach to data write-back to a backend data store. Write-back is accomplished from a grid cell to a data provider (e.g., OLAP (online analytical processing)) that handles UPDATE CUBE statements. The coordinates of the data to access from the cube are provided in a first cell. In a second cell, the user provides the value desired to send back to the cube and a reference to the first cell that contains data value coordinates property. A calculation is triggered to determine if there is a difference in the value at the coordinates provided in the first cell and the user-supplied value in the second cell. If there is a difference, then the properties of the cube value function associated with the first cell are used to construct the UPDATE CUBE statement to send back the user-provided value to the data location defined by the coordinates.

### BACKGROUND

Information workers at corporate entities, universities, public sector organizations, research facilities, etc., commonly use data grids such as spreadsheets with symmetrical data structures such as pivot tables (a data summary tool for data visualization) and OLAP (online analytical processing) cube functions for business process analysis and decision support. There are many instances when data values used in the business models must be entered manually by authorized users that have the knowledge of data otherwise not available in any automated data sources. For example, there may not be a data source that tracks the media articles covering gaming system games in various countries in a particular month.

Not all business models created in a spreadsheet fit into the fixed tabular structure of the pivot tables. Many users create asymmetric views and layouts using data retrieval functions (e.g., built-in OLAP spreadsheet functions). Data write-back functionality enables several highly desirable business scenarios for updating tabular data stored and retrieved from data analysis services. Many real world write-back scenarios and cell value updates require support for individual cells updates not organized into pivot tables. Thus, it is desirable to have a mechanism where data write-back can be performed from any data grid cell.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides the capability to write-back data from a spreadsheet with an asymmetrical cell layout to an OLAP (online analytical processing) data provider. More specifically, the architecture finds applicability for data write-back to OLAP providers that handle UPDATE CUBE statements.

More specifically, the coordinates of the data to access from the cube are provided in a first cell of the data grid. In a second cell, the user provides the value desired to send back to the cube and a reference to the coordinates provided in the first cell. A calculation is triggered to determine if there is a difference in the value at the coordinates provided in the first cell and the user-supplied value in the second cell. If there is a difference, then use the properties of the function associated with the first cell and construct the UPDATE CUBE statement. The algorithm creates the code necessary to send back the value the user provided. The update statement is constructed by combining the coordinates of the original data value location in the backend data store from the reference to the first grid cell which is capable of containing a property that holds the coordinates with the new data value set in the second cell.

In a more specific implementation, the problem is solved by utilizing an MDX (multidimensional expressions) property of the spreadsheet cells with OLAP functions, user data input cells and corresponding update trigger cells that contain a “trigger” function (e.g., user-defined function (UDF)) that can perform a realtime update or evaluate to update the trigger cell value to work in conjunction with subsequent deliberate user actions to commit updated values. As described in greater detail herein, the trigger function (e.g., a UDF) can be (optionally) parameterized to support value allocation rules (e.g., supported by an OLAP cube).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented write-back system in accordance with the disclosed architecture.

FIG. 2 illustrates a general system that employs write-back in accordance with the disclosed architecture.

FIG. 3 illustrates a computer-implemented write-back method in accordance with the disclosed architecture.

FIG. 4 illustrates further aspects of the method of FIG. 3.

FIG. 5 illustrates a block diagram of a computing system that executes write-back in accordance with the disclosed architecture.

### DETAILED DESCRIPTION

The disclosed architecture provides the capability to write-back data from a spreadsheet with an asymmetrical cell layout to an OLAP (online analytical processing) data provider. More specifically, the architecture finds applicability for data write-back to OLAP providers that handle UPDATE CUBE statements.

An OLAP data source that supports an UPDATE CUBE statement can be configured to accept user inputs and used for data write-back from symmetrical data structures (e.g., pivot tables). Thus, the disclosed architecture overcomes the need to have symmetrical structures such as a pivot table to enable updatable data write-back.

The architecture utilizes a property of spreadsheet cells with OLAP functions, user data input cells, and corresponding update trigger cells that contain a function/UDF (user-defined function) that can perform real time update or evaluate to update a trigger cell data value to work in combination with subsequent deliberate user actions to commit updated values. The trigger function can be parameterized to support value allocation rules supported by the OLAP cube.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

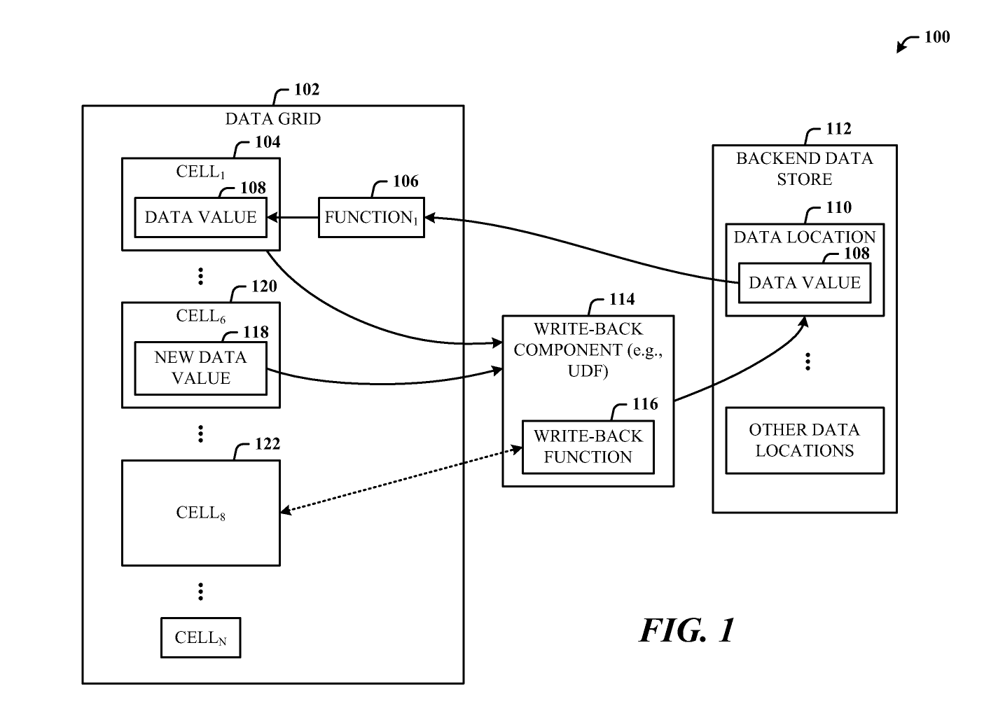

FIG. 1 illustrates a computer-implemented write-back system 100 in accordance with the disclosed architecture. The system 100 includes a data grid 102 having a first cell 104 (of many cells) associated with a function 106 (e.g., a cube value function). The function 106 retrieves a data value 108 from a data location 110 of a backend data store 112 (e.g., relational) and inserts the data value 108 into the first cell 104. The system 100 also includes a write-back component 114 that utilizes a write-back function 116 to write-back a new data value 118 of a second cell 120 (a manual data entry cell) to the data location 108 in the data store 112. The write-back component 114 obtains a property from the first cell 104 that contains coordinates to the data location 110, and additionally, the write-back component 114 obtains the new data value 118 from the second cell 120. The write-back component 114 then sends a statement (e.g., a UPDATE CUBE statement) back to the provider (the backend data store 112) for write-back of the new data value 118 into the data location 110. Although illustrated as outside the data grid 102, the write-back function 116 can be associated internally with a third cell 122 (a trigger cell) of the data grid 102.

The first cell 104 is associated with the property (that contains a definition statement) that contains coordinates of the data location 110 from which the data value 108 is retrieved. The new data value 118 is associated with a data entry cell 120, and write-back is triggered in response to the data value 108 in the first cell 104 being different than the new data value 118 in the second cell 120. As previously indicated, the write-back component 114 is in association with the data entry cell 120 and the trigger cell 122. The trigger cell 122 can have an associated user-defined function as the write-back function 116 that constructs, validates, and executes an update statement during calculation.

Alternatively, or in combination therewith, the write-back component 114 is in association with the data entry cell 120 and the trigger cell 122. The trigger cell 122 has an associated user-defined function as the write-back function 116 that constructs, validates, and returns an update trigger directive. The write-back component 114 utilizes the write-back function 116 to transform coordinates of the property associated with the first cell 104 and the new data value 118 of the manual entry data cell 120 into a statement that is sent to the data store 112 for the write-back of the new data value 118. The statement can be an UPDATE CUBE statement that is compatible with the data store 112, which can be an OLAP (online analytical processing) data store. The data grid 102 can be a spreadsheet.

Put another way, the write-back system includes a data grid having a first cell that maintains coordinates of a data value in a cell support function, the support function retrieves the data value from a data location of a data store defined by the coordinates and updates the data value property of the first cell, and a write-back component that utilizes a write-back function to write-back a new data value from a data entry cell to the data location in the data store, the write-back triggered in realtime in response to the new data value being different than the data value.

The write-back component utilizes the write-back function to transform coordinates of the property associated with the first cell and the new data value of the data entry cell into a statement that is sent to the data store for the write-back of the new data value. The write-back component is in association with the data entry cell and a user-defined function as the write-back function that constructs, validates, and executes an update statement during calculation. The write-back component is in association with the data entry cell and a user-defined function as the write-back function that constructs, validates, and returns an update trigger directive. The write-back component employs a function that optionally includes an allocation rule as a parameter.

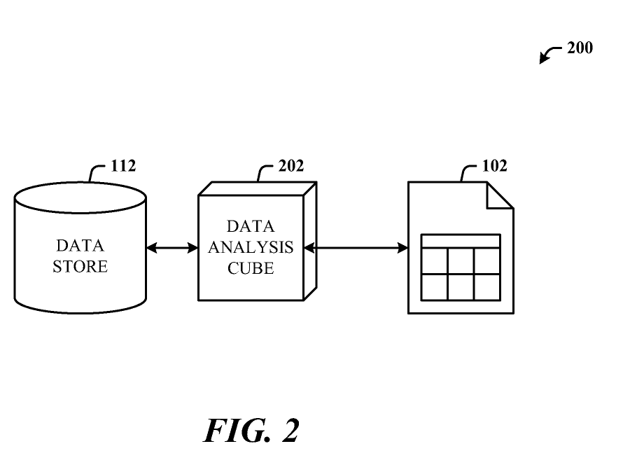

FIG. 2 illustrates a general system 200 that employs write-back in accordance with the disclosed architecture. The system 200 includes the data grid 102, which can be a spreadsheet file (also called a workbook), a data analysis cube 202, and the backend data store 112 (e.g., relational). The data grid 102 can be an asymmetrical structure where cells can be associated with cube functions suitable for access data values in the cube 202. The data grid 102 also includes the data entry cells, cells that contain trigger functions, and UDFs to construct cube statements. The cube 202 is an OLAP data source capable of supporting UPDATE statements (e.g., UPDATE CUBE statements). The cube 202 can be a secured cube at the cell level.

These and other details will now be described in greater detail.

In a conventional implementation using a spreadsheet, the user enters an equal sign (“=”) and utilizes a cube value function. The first parameter can be a connection parameter that points to an instance of an OLAP data provider. The syntax continues with a comma, followed by a list of dimensions that enable the retrieval of a specific data value. For example, a request can be made for sales for the United States for May of 2010. Once a closed parenthesis is entered, a value is received into that cell that indicates the amount of sales for the time period.

Using the disclosed architecture, which builds on the above steps, the user creates and utilizes a second cell (a manual data entry cell) in addition to the first existing cell (the cube value function cell). The second cell, located in the same spreadsheet file (also commonly referred as a workbook) as the first cell, need not be adjacent the first cell, but can be. The user can enter any desired new data value into the data entry cell, for which the user has an interest. In a third cell (a trigger cell), the user creates a formula that references the first cell (with the cube value function), and which retrieves two items and provides access to two items. One retrieved item is the original value that came into the spreadsheet from the backend data store, which in this example is the amount of sales in May 2010. The second retrieved item is the programmatically exposed MDX property that served as coordinates for that value in the backend data store, previously specified as a first parameter in the cube function for that data source. The property contains those dimensions.

The second parameter in that function is the value that the user has entered (in the data entry cell). Internally, a function (also referred to as a trigger function) evaluates whether the two values, the value in the cube value function and the value entered by the user, are different or identical. If different, the trigger function automatically initiates the update process. If not different, nothing happens. The cell associated with this trigger function is referred to as the write-back trigger cell. The update process can vary depending on what the implementer wants to do. For example, the update process can be a realtime update in the backend data store, or the process can be an instruction (also a processing directive) that the UDF will put in that cell as the value of that cell. In both cases, the process can be referred to as the trigger to update the backend data store.

More specifically, the coordinates of the data to access from the cube, are provided from one cell. In a second cell, the user provides the value desired to be entered, back to the cube. A calculation is then made to determine if a change has occurred. If there is a change, then use the properties of the cube value function (a support function). The UPDATE CUBE statement is then created so as to further create the algorithm and code necessary to send back the user-provided value. More generally, it is an update statement that references the cell that is capable of containing coordinates of the data value in the backend data store.

A cell that contains an OLAP function (e.g., CUBEMEMBER, CUBEVALUE, CUBERANKEDMEMBER, etc.) (and does not evaluate to an error) has a programmatically accessible property that contains spreadsheet validated MDX (multidimensional expressions) statement that the calculation engine uses to pull the data into the cell from the OLAP data source.

The returned property is not a complete SELECT statement, but can be a tuple expression (or definition) that looks similar to the following:

([Geography].[Geography Hierarchy].&[United States],
[Time].[Time].[Fiscal Month].&[July],
[KPI].[Scorecards].[KPI].&[1]&[101],
[Measures].[Actual])

When using MDX (multidimensional expressions), this property value is utilized for write-back scenarios because the same cell MDX statement used for data retrieval can also be used for data write-back without any modifications. Note that while the data retrieval does not require that the user include all cube dimensions in the function for retrieving the data, all dimensions are utilized for data write-back. For example, a hierarchy (Geography Hierarchy) and a flat dimension (GeographySecurityManual) can be used for dynamic dimension security. While it is not necessary to include the dimension GeographySecurityManual in the CUBEVALUE function for data retrieval, because the dimension pulls the same value as the Geography Hierarchy (the identifiers are identical), the dimension is included in the UPDATE CUBE statement to avoid potential default allocation by the OLAP engine of the write-back value across all members of the excluded dimensions.

With respect to creating a basic UDF for data write-back, a simple UPDATE CUBE statement for a single OLAP cube cell can look similar to the following:

```
UPDATE CUBE [ManualCube] SET
(
      [Geography].[Geography Hierarchy].&[United States],
      [Time].[Time].[Fiscal Month].&[July],
      [KPI].[Scorecards].[KPI].&[1]&[101],
      [Measures].[Actual]
)=1000;
```

The UDF can be used in the write-back trigger cell to construct, validate and, either execute the update statement during calculation or return an update trigger directive.

The simplest setup of an OLAP write-back UDF that demonstrates the concept may have only two parameters, and returns success or failure of the UPDATE CUBE statement. The parameters include a reference to a source cell that contains CUBEVALUE function, and a reference to a manual data entry cell (e.g., =CubeWriteBack(H20,E20))

The code behind the UDF checks for presence of the MDX property in the referenced source cell (H20, in the example above), validates that the manual entry cell (E20, in the example) is not empty, evaluates the values of both referenced cells for equality, and if the values are not equal, constructs and executes the UPDATE CUBE statement. The updates will not be made permanent at this time (e.g., until followed by COMMIT TRANSACTION statement executed in the same user session).

The UDF obtains the OLAP data source response regarding the outcome of the attempted update. This response is evaluated in the UDF code and the result placed in the trigger cell to notify the user of the success or failure of the cell value update operation.

An alternative technique for trigger cell based write-back is by creating a directive-based OLAP data source write-back UDF that executes the update statements in bulk. To support the bulk update scenario the UDF, rather than executing the update statement during calculation, evaluation can be to a directive that is used by another process. The directive contains instructions that indicate to the bulk update process to use the information contained in the trigger cells to programmatically build an update statement. The user can be provided with a user interface (UI) option to request the bulk update process once the user finishes making manual data entries and decides to submit the entries.

A directive-based OLAP write-back UDF utilizes two cell references as parameters, but instead of issuing an update statement during cell calculation, a write-back directive is returned. The two references include a reference to a source cell that contains CUBEVALUE function, and a reference to a manual data entry cell.

The “in trigger cell directive” version of the write-back function =CubeWriteBack(H20,E20) may return the following values that represent processing directives:
“UPDATE|MDXRetention!$H$20|MDXRetention!$E$20”. This is a pipe delimited directive that contains tree parts. The first part of the directive: UPDATE, instructs the bulk update process to issue an UPDATE CUBE statement. The second part contains a cell reference that serves as a source of the MDX statement. The third part is a cell reference that contains the new value that the user wants to update in the data source.
“No Update from: MDXRetention!$H$20” where cell H20 is the cell with CUBE function, an MDX property and its cell value is equal to the user input cell value (E20, in the example).
“Input Range is Not Numeric!” can be returned if manual input cell E20 is empty or holds some other non-numeric value.
“Value Range doesn't contain valid MDX!” can be returned if cell H20 does not have valid MDX property.

In all cases, except the first case, the bulk update process does not include the trigger cell into the update statement building process.

Following is sample code for a trigger cell UDF that returns a directive:

```
*******************************************************
CubeWriteBack User-Defined Function
*******************************************************
Function CubeWriteBack(valTestRange As Variant, inputRange As
Variant) As String
  Dim InputCell As Range
  Dim ValueCell As Range
  ‘Testing for valid input range input
  On Error GoTo ICellRangeErrorHandler
  Set InputCell = inputRange
  ‘Testing for valid test value range input
  On Error GoTo VCellRangeErrorHandler
  Set ValueCell = valTestRange
  ‘Ranges are valid
  ‘Need to validate MDX in test value cell - used in OLAP Cube Update
  statement
  On Error GoTo ErrorHandler
  ‘validating that both ranges contain only one cell
  If InputCell.Cells.Count > 1 Then
    CubeWriteBack = “Input Range contains multiple cells!”
    Exit Function
  End If
  If ValueCell.Cells.Count > 1 Then
    CubeWriteBack = “Value Range contains multiple cells!”
    Exit Function
  End If
  ‘validating user input as numeric
  If Not (IsNumeric(InputCell.Value)) Or _{—}
    IsEmpty(InputCell) Then
    CubeWriteBack = “Input Range is Not Numeric!”
    Exit Function
  End If
  ‘validating existence of MDX in the value test range
  If Len(ValueCell.MDX) = 0 Then
    CubeWriteBack = “Value Range doesn't contain valid MDX!”
    Exit Function
  End If
  ‘TODO: move this first for performance? Assess!
  If InputCell = ValueCell Then
    CubeWriteBack = “No Update from: ” & InputCell.Worksheet.Name
& “!” & InputCell.Address
  Else
    ‘TODO: build the update statement here?
    ‘modified 8/4/09 to prevent possible returned MDX attack
    CubeWriteBack = “UPDATE|” & InputCell.Worksheet.Name & “!”
& InputCell.Address & “|” & _{—}
      ValueCell.Worksheet.Name & “!” & ValueCell.Address ‘& “|”
      & InputCell.Value
      ‘ValueCell.MDX & “|” & InputCell.Value & “|” & AllocRule
    ‘TODO: handle update here
  End If
Exit Function
‘Error Handlers
ICellRangeErrorHandler:
  CubeWriteBack = inputRange & “ is not a valid range!”
Exit Function
VCellRangeErrorHandler:
  CubeWriteBack = valTestRange & “ is not a valid range!”
Exit Function
ErrorHandler:
  CubeWriteBack = “#N/A”
End Function
```

The directive-based update statement can be constructed by scanning all cells in the used range on each workbook sheet. If the process finds that the cell contains a CubeWriteBack function, the process checks whether the cell value contains an update directive and builds the cumulative update statement. Following is a sample code snippet:

```
‘**********************************************************************
‘Function that builds update statement
‘**********************************************************************
Function GetAllUpdateStatements( ) As String
  Dim strMDX As String
  Dim rangeAddress As String
  Dim rangeWithUpdate As Range
  Dim wks As Worksheet
  Dim cubeName As String
  For Each wks In ThisWorkbook.Worksheets
    Set rangeWithUpdate = GetRangeForUpdate(wks)
    If Not rangeWithUpdate Is Nothing Then
      rangeAddress = rangeWithUpdate.Address
      strMDX = strMDX & ConstructUpdates(rangeWithUpdate)
    End If
  Next
  ‘Aborting update if there are no UPDATE statements to send
  If Len(strMDX) = 0 Then Exit Function
  cubeName = Range(“CUBE_NAME”)
  GetAllUpdateStatements = “UPDATE CUBE [“ & cubeName & ”] SET ”
  GetAllUpdateStatements = GetAllUpdateStatements & strMDX
  ‘performing clean up
  If Right(GetAllUpdateStatements, 3) = “,” & vbCr & vbCr Then
    GetAllUpdateStatements = Left(GetAllUpdateStatements,
Len(GetAllUpdateStatements) − 3) & “;”
  End If
End Function
‘**********************************************************************
‘Function to retrieve the range of cells that contain values for OLAP update
‘**********************************************************************
Function GetRangeForUpdate(wks As Worksheet) As Range
  Dim rangeWithCWBFunc As Range
  Dim rCell As Range
  Dim i As Integer
  ‘iterating through every cell to get the list of all cells that contain CWB OLAP update
function
  For Each rCell In wks.UsedRange.Cells
    ‘collecting all cells that contain UDFs
    If InStr(rCell.Formula, “CubeWriteBack”) > 0 Then
      ‘Testing to see if the range contains UPDATE directive
      If Not Left(rCell.Value, 7) = “UPDATE|” Then GoTo SkipRange
      ‘Add to the collection cells to be updated
      If Not rangeWithCWBFunc Is Nothing Then
        Set rangeWithCWBFunc = Application.Union(rangeWithCWBFunc, rCell)
      Else
        Set rangeWithCWBFunc = rCell
      End If
    End If
SkipRange:
  Next
  ‘Return the range
  Set GetRangeForUpdate = rangeWithCWBFunc
End Function
‘**************************************************************************
‘Function to construct update statement string
‘**************************************************************************
Function ConstructUpdates(updateRange As Range)
  Dim rCell As Range
  Dim updateStatement As String
  Dim params( ) As String
  For Each rCell In updateRange
    ‘split and process using GetUpdateStatement
    ‘add commit transact here?
    params = Split(rCell.Value, “|”)
    updateStatement = updateStatement & GetUpdateStatement(Range(params(1)),
Range(params(2))) & “,” & vbCr & vbCr
  Next
  ConstructUpdates = updateStatement
End Function
‘**************************************************************************
‘Function to build individual OLAP Update Statement
‘**************************************************************************
Function GetUpdateStatement(valueRange As Range, mdxRange As Range) As String
  GetUpdateStatement = mdxRange.MDX
  ‘modified 12/18/09 to address non-US locale decimal separator issues
  ‘valueRange is already confirmed to be numeric by the UDF, so straight replace of comma
is valid
  GetUpdateStatement = GetUpdateStatement &
  “=” & Replace(valueRange.Value, “,”, “.”)
End Function ....
```

The resulting statement for updating values entered in two cells may look similar to the following (note that the individual value update segments are comma separated):

UPDATE CUBE [ManualCube] SET
([Geography].[Geography Hierarchy].&[United States],[Time].-
[Time].[Fiscal Month].&[July],[Measures].[Actual],[KPI].[KPI
Name].&[1]&[101])=9280,
([Geography].[Geography Hierarchy].&[779],[Measures].[Actual],[KPI].-
[KPI Name].&[1]&[101],[Time].[Time].[Fiscal
Month].&[July])=9681;

The UPDATE CUBE statement supports allocation rules. The end user can include an allocation rule parameter in the UDF. The UDF that supports allocation rules can reference a named range that will contain an allocation rule string. For example:

=CubeWriteBack(J1102,E1102,USE_EQUAL_ALLOCATION), where USE_EQUAL_ALLOCATION is a named range that contains string USE_EQUAL_ALLOCATION. The named range reference enables support for more complex (non-constant) allocation rules such as USE_WEIGHTED_ALLOCATION BY . . . and USE_WEIGHTED_INCREMENT BY . . . where the complex allocation rule can be defined once in a single cell and used in many data write-back trigger cells by referencing that cell.

The resulting update statement with a simple equal allocation rule from the example above can look similar to the following:

```
UPDATE CUBE [ManualCube] SET
(
      [Geography].[Geography Hierarchy].&[United States],
      [Time].[Time].[Fiscal Quarter].&[Q1-2011],
      [KPI].[Scorecards].[KPI].&[1]&[101],
      [Measures].[Actual]
)=8228 USE_EQUAL_ALLOCATION;
```

When employing the trigger cell based write-back approach, the same statement (e.g., MDX) that is used for data retrieval is also used for data write-back, making data grid (e.g., spreadsheet) setup simpler, and consequently, less error prone.

Additionally, besides supporting free form grid layout (asymmetrical) the cell level based OLAP write-back approach also allows the authors of the grid to construct complex statements for advanced data retrieval and write-back scenarios. For example, the user can construct CUBEVALUE functions to write-back directly to the .DATAMEMBER for scenarios where the data for a specific measure does not have to roll up to the next hierarchy level. In several cases, users may enter arbitrary percentage targets that do not roll up to other hierarchy members. This scenario is easily accommodated by entering the following CUBEVALUE function into the source cell:

=CUBEVALUE(ConnectionFile,“[Geography].[Geography Hierarchy].-
&[“&GeoID&”].DATAMEMBER“,”[GeographySecurityFlatFile].-
[Geography Security FlatFile].&[“&GeoID&”]”,E$9,$C11,Time,
Currency,Forecast,DS,Customer)

The MDX property of this cell may look similar to the following:

([Geography].[Geography Hierarchy].&[United States].DATAMEMBER,
[Measures].[Actual], [KPI].[KPI Name].&[1]&[101], [Time].[Time].-
[Fiscal Month].&[July])

The update statement writes the cell value directly for that hierarchy member.

The disclosed write-back approach also allows greater control over the layout with cell referencing. Business users can have a dedicated reference to the manual data entry sheet which is easy to accomplish using cell referencing. Any cell with CUBE function referenced with an equal (“=”) sign in another cell inherits the property of the parent cell.

As a general summary, CUBE functions in conjunction with the trigger cell UDFs and an OLAP data source that supports UPDATE CUBE statement can make spreadsheets with complex formula driven business rules into a data entry tool with real time collaboration. Advanced scenarios include allocations, writing or modifying values for specific member of the hierarchy, etc. If the user can write an MDX statement, the trigger cell UDF allows the user to write the statement back to the data source and make it available in realtime to all users of that data source.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

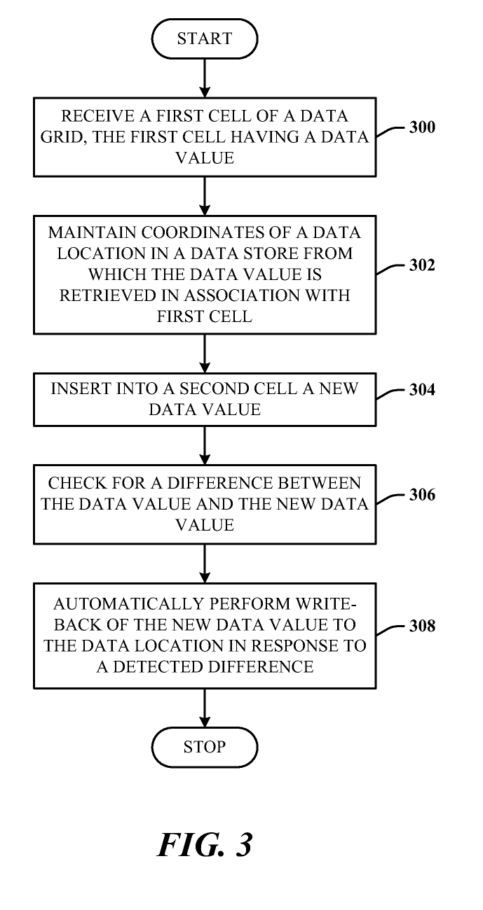

FIG. 3 illustrates a computer-implemented write-back method in accordance with the disclosed architecture. At 300, a first cell of a data grid is received, the first cell having a data value. At 302, coordinates of a data location in a data store from which the data value is retrieved are maintained in association with the first cell. At 304, a new data value is inserted into a second cell. At 306, a check is made for a difference between the data value and the new data value. At 308, write-back of the new value is automatically performed to the data location in response to a detected difference.

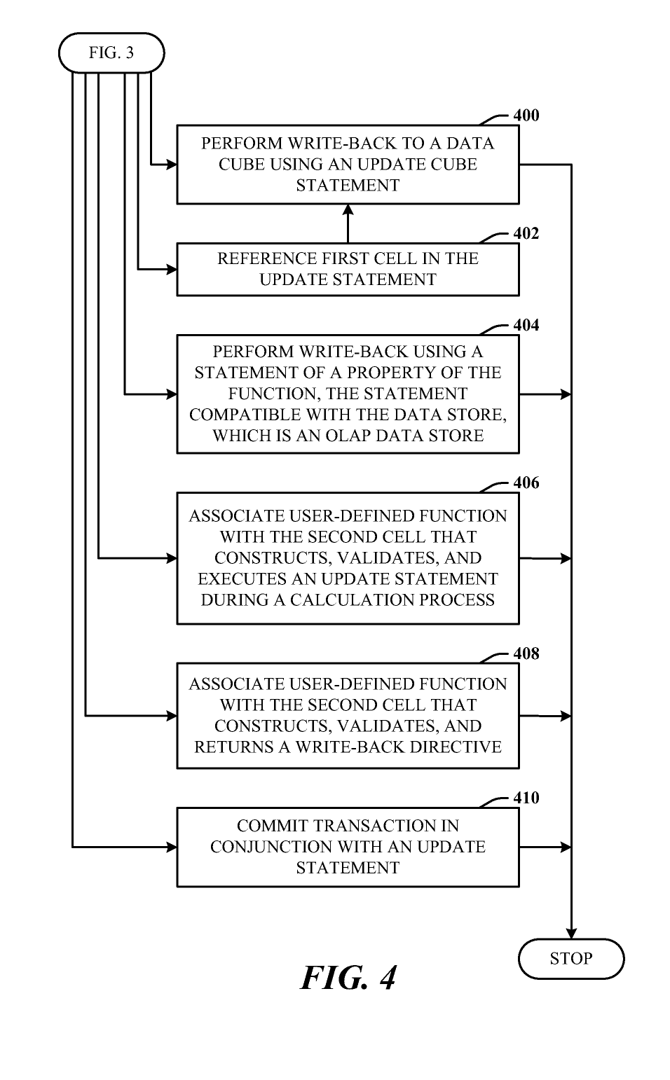

FIG. 4 illustrates further aspects of the method of FIG. 3. Note that the arrowing indicates that each block represents a step that can be included, separately or in combination with other blocks, as additional aspects of the method represented by the flow chart of FIG. 3. At 400, the write-back to a data cube is performed using an UPDATE CUBE statement. At 402, write-back of the new data value to the data location is performed using a write-back function that takes as input at least the coordinates and the new data value. At 404, the write-back is performed using a statement that is compatible with the data store, which is an OLAP data store. At 406, a user-defined function is associated with the second cell that constructs, validates, and executes an update statement during a calculation process. At 408, a user-defined function is associated with the second cell that constructs, validates, and returns a write-back directive. At 410, a transaction is committed in conjunction with an update statement.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

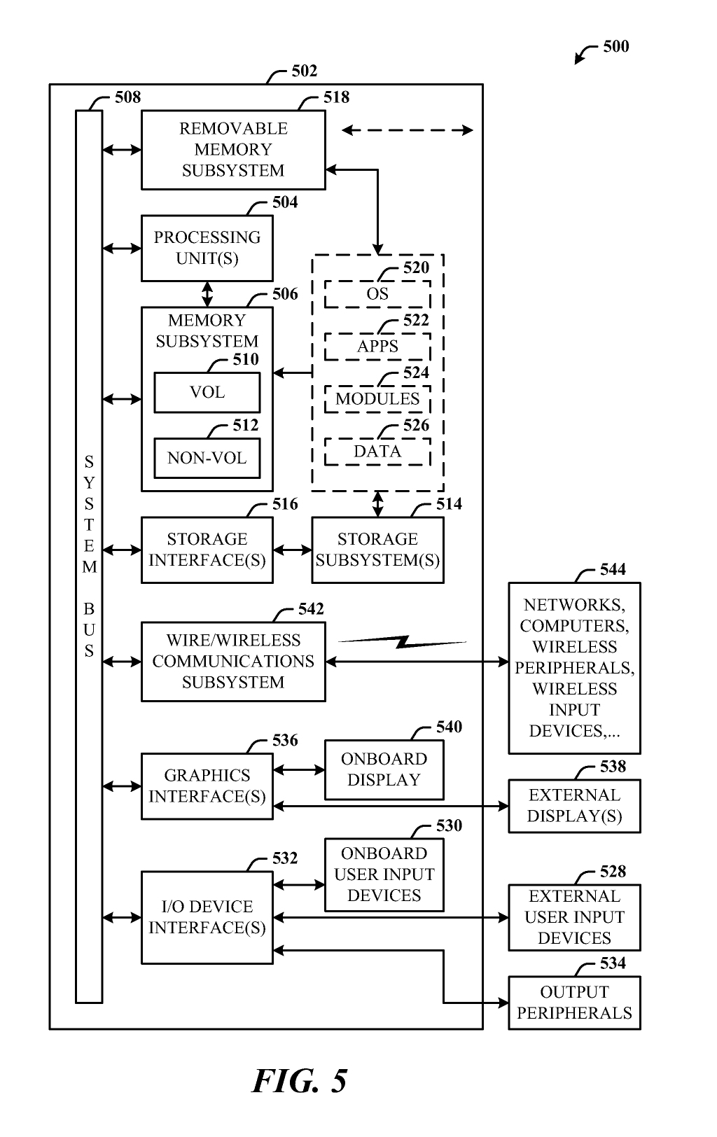

Referring now to FIG. 5, there is illustrated a block diagram of a computing system 500 that executes write-back in accordance with the disclosed architecture. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The one or more application programs 522, other program modules 524, and program data 526 can include the entities and components of the system 100 of FIG. 1, the entities and components of the system 200 of FIG. 2, and the methods represented by the flowcharts of FIGS. 3 and 4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented write-back system having computer readable media that store executable instructions executed by a processor, comprising:
a data grid having a first cell associated with a function, the function retrieves a data value from a data location of a backend data store and inserts the data value into the first cell; and
a write-back component that utilizes a write-back function to write-back a new data value to the data location in the data store.

2. The system of claim 1, wherein the first cell is associated with a property that contains coordinates of the data location from which the data value is retrieved.

3. The system of claim 1, wherein the new data value is associated with a data entry cell and write-back is triggered in response to the data value in the first cell being different than the new data value in the data entry cell.

4. The system of claim 3, wherein the write-back component is in association with the data entry cell and a trigger cell, the trigger cell associated with a user-defined function as the write-back function that constructs, validates, and executes an update statement during calculation.

5. The system of claim 3, wherein the write-back component is in association with the data entry cell and a trigger cell, the trigger cell associated with a user-defined function as the write-back function that constructs, validates, and returns an update trigger directive.

6. The system of claim 1, wherein the write-back component utilizes the write-back function to transform coordinates of a property associated with the first cell and the new data value of a manual data entry cell into a statement that is sent to the data store for the write-back of the new data value.

7. The system of claim 6, wherein the statement is an UPDATE CUBE statement that is compatible with the data store, which is an OLAP (online analytical processing) data store.

8. The system of claim 6, wherein the data grid is a spreadsheet.

9. A computer-implemented write-back system having computer readable media that store executable instructions executed by a processor, comprising:
a data grid having a first cell that maintains coordinates of a data value in a cell support function, the support function retrieves the data value from a data location of a data store defined by the coordinates and inserts the data value into the first cell; and
a write-back component that utilizes a write-back function to write-back a new data value from a data entry cell to the data location in the data store, the write-back triggered in realtime in response to the new data value being different than the data value.

10. The system of claim 9, wherein the write-back component utilizes the write-back function to transform coordinates of a property associated with the first cell and the new data value of the data entry cell into a statement that is sent to the data store for the write-back of the new data value.

11. The system of claim 9, wherein the write-back component is in association with the data entry cell and a user-defined function as the write-back function that constructs, validates, and executes an update statement during calculation.

12. The system of claim 9, wherein the write-back component is in association with the data entry cell and a user-defined function as the write-back function that constructs, validates, and returns an update trigger directive.

13. The system of claim 9, wherein the write-back component has an associated function that employs an allocation rule as a parameter.

14. A computer-implemented write-back method executed by a processor, comprising:
receiving a first cell of a data grid, the first cell having a data value;
maintaining coordinates of a data location in a data store from which the data value is retrieved in association with the first cell;
inserting into a second cell a new data value;
checking for a difference between the data value and the new data value; and
automatically performing write-back of the new data value to the data location in response to a detected difference.

15. The method of claim 14, further comprising performing the write-back to a data cube using an UPDATE CUBE statement.

16. The method of claim 15, further comprising writing back the new data value to the data location using a write-back function that takes as input at least the coordinates and the new data value.

17. The method of claim 14, further comprising performing the write-back using a statement that is compatible with the data store, which is an OLAP data store.

18. The method of claim 14, further comprising associating a user-defined function with the second cell that constructs, validates, and executes an update statement during a calculation process.

19. The method of claim 14, further comprising associating a user-defined function with the second cell that constructs, validates, and returns a write-back directive.

20. The method of claim 14, further comprising committing a transaction in conjunction with an update statement.
